(19) United States
(12) Patent Application Publication
(10) Pub. No.: US 2019/0283154 A1
(43) Pub. Date: Sep. 19, 2019

(54) TRANSPORTABLE MACHINING UNIT

(71) Applicant: FESTOOL GMBH, Wendlingen (DE)

(72) Inventor: Dominic Richard ENDER, Nürtingen (DE)

(21) Appl. No.: 16/339,553

(22) PCT Filed: Oct. 5, 2016
(86) PCT No.: PCT/EP2016/073739

§ 371 Date: Apr. 4, 2019

(51) Int. Cl. B23D 45/06

(52) U.S. Cl. CPC B23D 45/068

(57) ABSTRACT

A transportable machining unit with a tool for machining a workpiece, including a box-shaped support structure placed on a support and having a workpiece support plate used to support the workpiece to be machined, and a control device with an operating device arranged on the outside of the support structure. The operating device includes a first rotary wheel and a second rotary wheel, wherein it is possible for a first operating parameter associated with an operation of the tool to be entered into the control device via the first rotary wheel and a second operating parameter associated with the operation of the tool to be entered into the control device via the second rotary wheel.

The invention relates to a transportable machining unit, in particular a circular table saw, with a tool for machining a workpiece, comprising a box-shaped support structure which can be placed on a support and which has a workpiece support plate which can be used to support the workpiece to be machined, and a control device with an operating device arranged externally on the support structure.

DE 20 2004 009 123 U1 describes a circular table saw with a housing which is provided with essentially closed outer surfaces on the circumference and underside. The housing carries a worktop with a supporting surface. A mitre device and its operating front are provided on the front of the housing.

One object of the invention is to improve the operability of a transportable machining unit of the type mentioned above.

This object is achieved by the features specified in the characterising part of Claim 1. According to the invention, the operating device comprises a first rotary wheel and a second rotary wheel, wherein a first operating parameter associated with an operation of the tool can be entered into the control device via the first rotary wheel and a second operating parameter associated with the operation of the tool can be entered into the control device via the second rotary wheel.

According to the invention, the operating device therefore comprises two rotary wheels, wherein each rotary wheel is used to enter a respective operating parameter. Since a separate rotary wheel is provided for each of the operating parameters, the operating parameters can be entered quickly and easily. In particular, it is not necessary to first select which operating parameter is to be entered by further user inputs, such as pressing configuration keys. Instead, all that is needed to enter an operating parameter is simply operating the rotary wheel assigned to the operating parameter to be entered. As a result, the operability of the transportable machining unit is increased.

When entering an operating parameter, it is expedient to enter a value for the corresponding operating parameter. In particular, the value to be entered is selected by turning the assigned rotary wheel. In accordance with a preferred embodiment, the rotary wheels can be designed as rotary press wheels. A selected value can then be confirmed by pressing the rotary wheel and/or accepted by the control unit when the rotary wheel is pressed.

The operating parameters that can be entered are related to the operation of the tool. For example, the operating parameters that can be entered are used to set the position or the drive of the tool. Preferably, the operating parameters concern the height or angle of the tool relative to the support plate. Furthermore, the operating parameters may also concern a speed, torque and/or drive mode of a drive unit driving the tool.

Advantageous further developments are the subject matter of the dependent claims.

Preferably, a fixed assignment between the rotary wheels and the operating parameters is defined in the control unit. The fixed assignment between the rotary wheels and the operating parameters enables fast and intuitive input of the operating parameters. In particular, it is not possible to enter the first operating parameter with any other than the first rotary wheel and/or to enter the second operating parameter with any other than the second rotary wheel.

It is expedient for the control means to have at least one quick selection button and the control device to be adapted to set the first and/or second operating parameter to a predetermined value when the quick selection button is pressed. In this way, the operating parameters can be set very quickly and easily to predefined values. The predetermined values'are, for example, values to which the operating parameters are frequently set.

In the preferred embodiment, the operating device has several quick selection buttons, wherein a fixed assignment between the quick selection buttons and the operating parameters is defined in the control device. In particular, at least one quick selection button is assigned to the first operating parameter and at least one second quick selection button is assigned to the second operating parameter. Due to the fixed assignment between the quick selection buttons and the operating parameters, fast and intuitive input of the operating parameters is possible.

According to a preferred embodiment, the rotary wheels and the quick selection buttons are arranged in such a way that the quick selection buttons assigned to the first operating parameter and the first rotary wheel are located on the first side of an imaginary dividing line and the quick selection buttons assigned to the second operating parameter and the second rotary wheel are located on the second side of the imaginary dividing line. The operating elements belonging to the same operating parameter are therefore arranged spatially as a group. In this way, which control elements belong to which operating parameter can be identified rapidly and intuitively.

According to a further embodiment, the control device comprises an electrical actuator and is adapted to adjust the position of the tool relative to the workpiece support plate according to the first and/or second operating parameter using the electrical actuator. Accordingly, the tool is positioned by means of an electric actuator, for example an electric linear and/or pivot drive. The positioning of the tool can thus be adjusted quickly and precisely.

Preferably, the electrical actuator is configured to position the tool along first and second degrees of freedom, and the controller is adapted to adjust the position of the tool along the first degree of freedom in accordance with the first operating parameter using the electrical actuator and to adjust the position of the tool along the second degree of freedom in accordance with the second operating parameter.

For example, the electrical actuator is designed to move the tool along a vertical translation axis and/or to pivot it about a horizontal pivot axis. If the transportable machining unit is designed as a circular table saw, the operating parameters can be used to adjust the height and mitre angle of the saw blade, for example.

Preferably, the controller is arranged to set the first and/or second operating parameter to a value corresponding to a maximum and/or minimum displacement along a vertical translation axis and/or a maximum and/or minimum pivoting about a horizontal pivot axis when a quick selection button is pressed. Minimal pivoting refers in particular to minimal pivoting in terms of absolute value. In most cases, the workpiece is machined at these values. The fact that these values can be selected directly using the quick selection buttons means that the transportable machining unit can be set quickly and conveniently in these cases.

The operating device is arranged in particular on a circumferential wall of the support structure. Preferably, the axes of rotation of the rotary wheels are orthogonal to the circumferential wall. The rotary wheels and the quick selection buttons are preferably arranged in a control panel. In particular, the rotary wheels are arranged side by side and at the same height. It is also useful to arrange the quick selection buttons next to each other and at the same height. Preferably, the quick selection buttons are located directly below the rotary wheels.

According to a preferred embodiment, a recess is provided in the circumferential wall in which the operating device is arranged. Preferably, the operating elements of the operating device do not project over the circumferential wall, so that the transportable machining unit has a substantially rectangular horizontal cross-section. This ensures that the transportable machining unit is particularly easy to store and transport.

In accordance with a preferred embodiment, the support structure has coupling means and is adapted to provide, in a state in which the transportable machining unit together with at least one box-shaped body forms a vertical stack, a releasable vertically tension-proof coupling with the at least one box-shaped body, wherein the coupling means are at least partially arranged in the recess.

Expediently, the operating device comprises a display adapted to display the first and/or second position parameter. The display can be used, for example, to inform the user which value is currently selected by a rotary wheel.

The display is preferably located above the rotary wheels on a circumferential wall of the support structure and angled upwards relative to the circumferential wall.

A display arranged in this way is particularly easy to read during operation, when a user typically looks down at the transportable machining unit from above. In addition, a display arranged in this way acts as a kind of canopy for the operating elements and protects them from dirt and accidental actuation from above.

According to a further embodiment, one of the rotary wheels includes an incremental encoder. Preferably, each of the rotary wheels includes a respective incremental encoder.

An exemplary embodiment is explained below with reference to the drawing. Wherein:

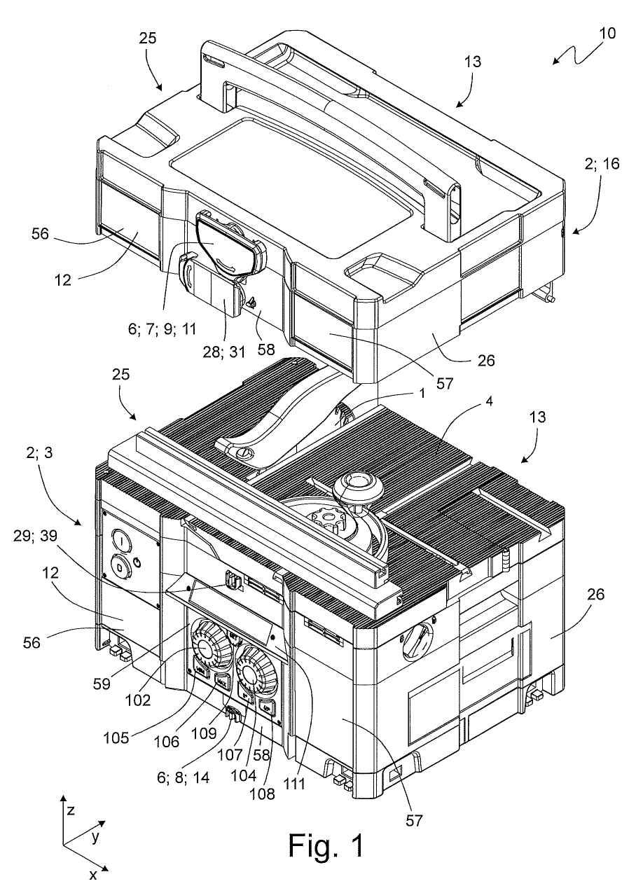

FIG. 1 shows a perspective representation of a transportable machining unit,

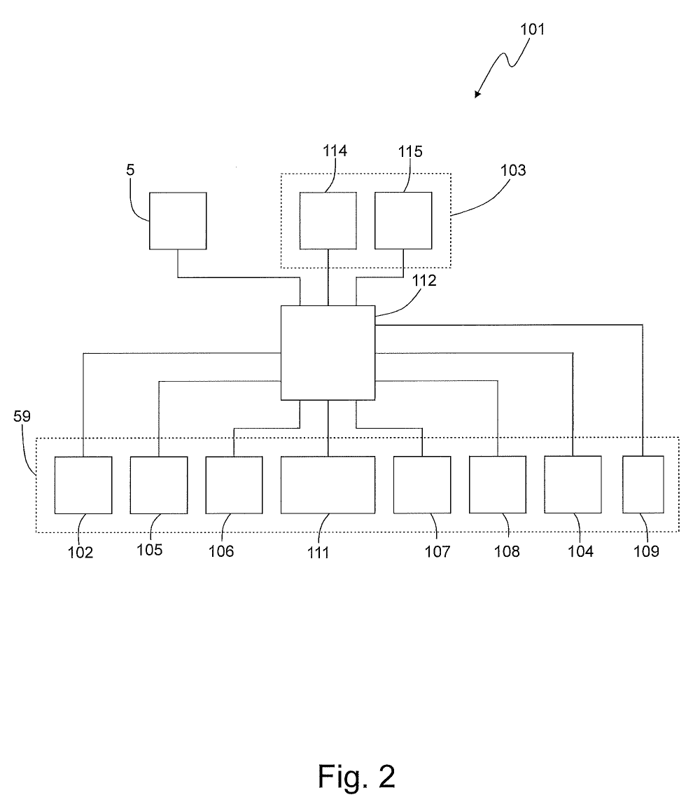

FIG. 2 shows a front view of the transportable machining unit,

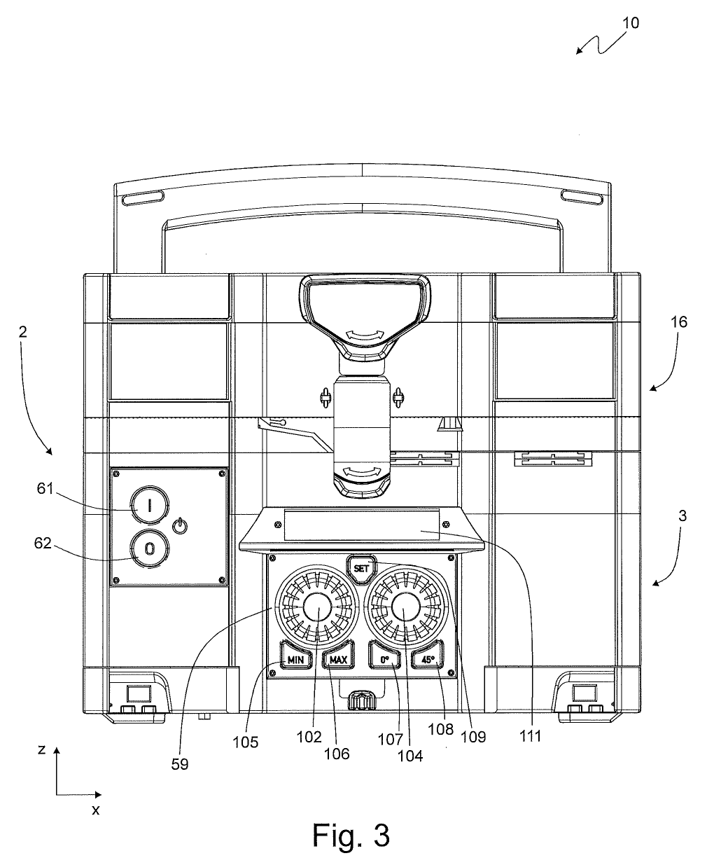

FIG. 3 shows a schematic block diagram of a control device

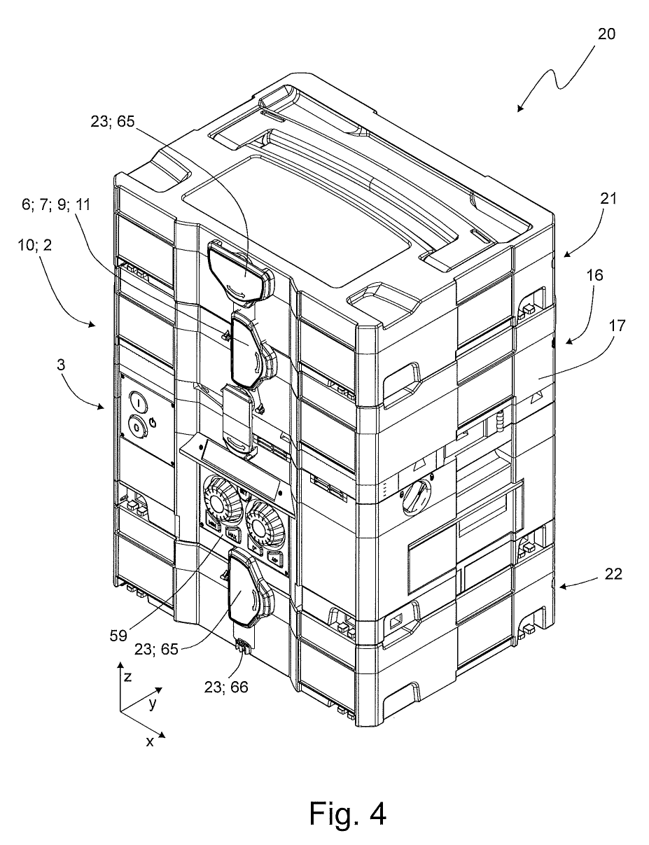

FIG. 4 shows a transportable machining unit in a stack.

The transportable machining unit 10 extends in a vertical direction parallel to the z axis shown in FIG. 1, in a longitudinal direction parallel to the x-axis shown in FIG. 1 and in a transverse direction parallel to the y-axis shown in FIG. 1. The x-axis, y-axis and z-axis are orthogonal to each other.

In the figures shown, the transportable machining unit 10 is designed as a circular table saw. Alternatively, the transportable machining unit 10 can also be designed as a different machine, in particular a different semi-stationary machine, such as a router, scroll saw or edge grinder. In this context, a semi-stationary machine is defined in particular as a machining unit which is placed on a support during workpiece machining and which can be carried by one person during transport.

The transportable machining unit 10 has a tool 1 which is used for machining a workpiece. In the case of the embodiment shown in the figures, the tool 1 is designed exemplarily as a saw blade. The tool 1 reaches through an opening provided in the workpiece support plate 4.

The transportable machining unit 10 comprises a box-shaped support structure 2 which can be placed on a support and which has a workpiece support plate 4 which can be used to place the workpiece to be machined. The box-shaped support structure 2 has an essentially cuboid basic shape in which the outer surfaces, preferably all outer surfaces, are essentially closed.

In the embodiment shown, the support structure 2 has, by way of example, a lower part 3 and an upper part 16. The lower part 3 is box-shaped. The functional units required for machining the workpiece are provided on or in the lower part 3, so that the lower part 3 itself already represents a transportable machining unit. The upper part 16, which is designed in the form of a cover hood, is optionally provided. As explained in detail below, its primary purpose is to accommodate the transportable machining unit 10 for transport in a stack 20.

The support structure 2 has four circumferential walls aligned orthogonally to each other. The circumferential walls comprise a front wall 12, a rear wall 13, as well as side walls 25 and 26. The front wall 12 and the rear wall 13 are aligned parallel to the longitudinal direction, and the side walls 25, 26 are aligned parallel to the transverse direction.

The transportable machining unit 10 comprises a control unit 101 with an operating device 59 arranged externally on the support structure 2. In the example shown, the operating device 59 is arranged on the front wall 12. Alternatively, the control 59 may also be located on one of the side walls 25 and 26, or on the rear wall 13. It is also possible that control elements of the operating device 59 are distributed over several circumferential walls.

The operating device 59 comprises a first rotary wheel 102 and a second rotary wheel 104. The first rotary wheel 102 can be used to enter a first operating parameter related to the operation of the tool 1 into the control unit 101. A second operating parameter related to the operation of tool 1 can be entered into the control unit 101 via the second rotary wheel 104.

Consequently, each of the operating parameters has its own rotary wheel 102, 104, so that the input of the operating parameters can be carried out quickly and easily.

The operating parameters that can be entered are used, for example, to set the position or the drive of the tool. Preferably, the operating parameters relate to a height or an angle of the tool 1 relative to the workpiece support plate 4. Furthermore, the operating parameters can also relate to a speed, a torque and/or a drive mode of a drive unit 5 driving the tool 1. It is expedient for at least one of the operating parameters to relate to the position and at least another of the operating parameters to relate to the drive of the tool.

In the example shown, the operating device 59 has exactly two rotary wheels 102 and 104. The operating device 59 can also have three or more rotary wheels, depending on how many operating parameters are to be entered directly via their own rotary wheel.

FIG. 2 shows a schematic block diagram of the control device 101. The control device 101 comprises the operating device 59 discussed above as well as a control unit 112, a drive unit 5 and an electric actuator 103.

The operating device 59 comprises a plurality of control elements. As already described above, the operating device 59 comprises the first rotary wheel 102 and the second rotary wheel 104. In addition, the operating device 59 comprises exemplary quick selection buttons 105, 106, 107 and 108, a calibration button 109 and a display 111.

The control unit 112, for example, is designed as a microcontroller. The operating device 59 and/or its operating elements are connected to the control unit 12. In addition, the drive unit 5 and electrical actuator 103 are connected to the control unit 12 by way of example.

The electrical actuator 103 comprises, as an example, a linear drive 114 and a pivot drive 115, which are designed to position the tool 1 relative to the workpiece support plate 4 according to a control by the control unit 112.

The drive unit 5, for example, is designed as a rotary drive and serves to mechanically drive the tool 1. The drive unit 5 is attached to the lower part 3 ready for operation, so that the drive unit 5 remains in the lower part 3 when the workpiece 1 is machined by the tool 1 driven by the drive unit 5.

The control unit 12, the drive unit 5 and the electric actuator 103 are exemplarily arranged inside the support structure 2 and therefore not to be seen in FIGS. 1, 3 and 4.

FIG. 3 shows the operating device 59 from the front. In the embodiment shown, the rotary wheels 102, 104 and the quick selection buttons 105, 106, 107, 108 are arranged exemplarily in a control panel. The rotary wheels 102, 104 are arranged directly next to each other and are located at the same height and/or in the same vertical area. The centres of the wheels 102, 104 lie on an imaginary horizontal straight line. The quick selection buttons 105, 106, 107, 108 are located directly below the rotary wheels 102, 104. The quick selection buttons 105, 106, 107, 108 are arranged next to each other and are located at the same height and/or in the same vertical area. A calibration button 109 is provided between the two rotary wheels 102, 104 and above the imaginary horizontal straight line running through the two centres of the rotary wheels 102, 104.

As mentioned above, the rotary wheels 102, 104 are used to enter the operating parameters into the control unit 101. For this purpose, the control unit 12 may, for example, be designed to detect a position and/or a change in position of the rotary wheels 102, 104 and to convert the detected position or change in position into a value for one of the operating parameters and store it. The rotary wheels 102 and 104, for example, each comprise a rotary encoder, for example an incremental encoder and/or an absolute value encoder, which provides the control unit 112 with an electrical signal according to a position and/or change of position of the respective rotary wheel 102, 104. The control unit 112 is designed to provide a value for the operating parameter to be entered according to the received electrical signal or to store this value internally.

The value to be entered can be selected in this way by turning the assigned rotary wheel 102, 104. According to a preferred embodiment, the rotary wheels 102, 104 can be designed as rotary press wheels. A selected value can then be confirmed by pressing the respective rotary wheel 102, 104. For example, the control unit 112 is designed to, when a rotary wheel 102, 104 is pressed, accept the value currently selected by this rotary wheel 102, 104 for the corresponding operating parameter and/or store it in an internal memory.

The control device 101 preferably defines a fixed assignment between the rotary wheels 102, 104 and the operating parameters. Thus, the first operating parameter is permanently assigned to the first rotary wheel 102, and the second operating parameter is permanently assigned to the second rotary wheel 104. It is expedient that the first operating parameter cannot be entered with any rotary wheel other than the first rotary wheel 102 and the second parameter cannot be entered with any rotary wheel other than the second rotary wheel 104. Such an assignment between the rotary wheels 102 and 104, for example, is configured in the control unit 112. In particular, the control device 101 or the control unit 12 is configured in such a way that it is not possible to change this fixed assignment, for example by actuating control elements of the operating device 59.

As already mentioned above, the operating device 59 is exemplary equipped with the quick selection buttons 105, 106, 107 and 108. The control device 101 and the control unit 12, respectively, are arranged to set one of the operating parameters to a predetermined value when one of the quick selection buttons 105, 106, 107 and 108 is pressed.

Preferably, a fixed assignment between the quick selection buttons 105, 106, 107 and 108 and the operating parameters is defined in the control unit 101 or in the control unit 112. For example, the quick selection buttons 105 and 106 are assigned to the first operating parameter and the quick selection buttons 107 and 108 to the second operating parameter. It is expedient for the control unit 12 to be adapted to detect an operation of the quick selection buttons 105 or 106 as input of the first operating parameter and an operation of the quick selection buttons 107 or 108 as input of the second operating parameter.

The operating elements of the operating device 59—i.e. the rotary wheels 102, 104 and the quick selection buttons 105, 106, 107 and 108—are arranged exemplarily in such a way that the operating elements assigned to the same operating parameters are grouped. For example, the quick selection buttons 105 and 106 assigned to the first operating parameter and the first rotary wheel 102 are located on the first side of an imaginary vertical dividing line. The quick selection buttons 107 and 108 assigned to the second operating parameter and the second rotary wheel 104 are located on a second side of the imaginary vertical dividing line. In the example shown, the quick selection buttons 105 and 106 are located directly below the first rotary wheel 102 and the quick selection buttons 107 and 108 are located directly below the second rotary wheel 104.

As mentioned above, the operating parameters can be used, for example, to set the position of the tool 1 relative to the workpiece support plate 4. In this case, the tool 1 can be positioned using, for example, the electrical actuator 103. The actuator 103 is especially designed to position the tool 1 along a first and a second degree of freedom. The positioning along the degrees of freedom can be adjusted via the operating parameters. In particular, the control unit 12 is designed to control the electrical actuator 103 in accordance with the entered operating parameters so that it moves the tool 1 into a position defined by the entered operating parameters.

In the transportable machining unit 10, which is exemplarily designed as a circular table saw, the two degrees of freedom correspond, for example, to the height and mitre angle of the saw blade. Expediently, the first degree of freedom corresponds to a displacement of the tool 1 in the vertical direction and the second degree of freedom to a tilting of the tool 1 about a horizontal pivot axis, in particular about a pivot axis parallel to the y-axis. With the quick selection buttons 105, 106, 107 and 108, the operating parameters (the height and the mitre angle in the explained example) can be set to particularly frequently used values.

As an example, the control unit 12 is designed to set the first operating parameter to a value corresponding to a maximum or minimum displacement in the vertical direction when the quick selection button 105 or 106 is pressed. The control unit 12 is also designed exemplarily to set the second operating parameter when pressing the quick selection buttons 107 or 108 to a value which corresponds to a maximum or minimum pivoting about the horizontal pivot axis—i.e. a maximum or minimum mitre angle.

FIG. 3 shows an exemplary assignment of the quick selection buttons 105, 106, 107 and 108. The quick selection buttons 105, 106, 107 and 108 are exemplarily provided with corresponding markings, which serve as an indication for the button assignment. The markings can, of course, also be different or omitted. The quick selection button 105 is marked “MIN” and assigned a value that corresponds to a minimum height—i.e. the lowest possible positioning in the vertical direction—of the tool 1 relative to the workpiece support plate 4. The quick selection button 106 is marked “MAX” and assigned a value that corresponds to the maximum height—i.e. the highest possible positioning in the vertical direction—of the tool 1. The quick selection button 107 is marked “0° ” and assigned a value corresponding to a mitre angle of 0°. In particular, the value that can be set with the quick selection button 107 can correspond to a minimum mitre angle or a minimum mitre angle in terms of absolute value. For example, the circular table saw can be designed in such a way that negative mitre angles such as −1° to −2° degrees can also be set, and the minimum mitre angle—i.e. 0°—can then be set with the quick selection button 107. The quick selection button 108 is marked “45°” and assigned a value corresponding to a mitre angle of 45°. This value can, for example, represent the maximum adjustable mitre angle. Of course, it is also possible that a larger mitre angle can be set and the value assigned to the quick selection button 108 does not correspond to the largest mitre angle, but instead to a usual or frequently used mitre angle.

Further exemplary details of the transportable machining unit 10 are described below.

The operating device 59 is arranged on a circumferential wall of the support structure 2. The rotation axes of the rotary wheels 102, 104 are orthogonal to the circumferential wall. In the example shown, the operating device 59 is arranged on the front wall 12.

A recess is provided in the front wall 12 in which the operating device 59 is arranged. As can be seen in FIG. 1, the front wall 12 of the support structure 2 has two side wall sections 56 and 57 in the longitudinal direction and a central wall section 58 which is offset to the rear in relation to the lateral wall sections 56 and 57—i.e. in the transverse direction towards the rear wall 13—so that the front wall 12 has a recess in the centre in the longitudinal direction. In the example shown, the recess extends over the entire vertical area of the front wall 12 from the underside of the support structure 2 to the upper side—i.e. over the lower part 3 and the upper part 16. The operating device 59 is provided at the middle wall section 58. The operating device 59 is located on the lower part 3. In particular, the operating device 59 is dimensioned in such a way that it does not project transversely beyond the side wall sections 56, 57.

As already mentioned above, the operating device 59 exemplarily includes a display 111. The display 111 is designed to display the first and/or the second position parameter. As an example, the display 111 is arranged above the rotary wheels 102, 104 on the front wall 12 of the support structure 2 and angled upwards relative to the front wall 12.

The transportable machining unit 10 is equipped with a switch-on button 61 and a switch-off button 62. As shown in FIG. 3, the switch-on button 61 and the switch-off button 62 can be located on the front panel 12. The switch-on button 61 is preferably used to start the drive of the tool 1 by the drive unit 5 and the switch-off button 62 is preferably used to stop the drive of the tool 1 by the drive unit 5. Preferably the switch-on button 61 and the switch-off button 62 are connected to the control unit 112. The switch-on button 61 and/or switch-off button 62 is preferably provided in addition to the rotary wheels 102, 104.

As discussed above, the support structure 2 exemplary has an upper part 16. The upper part 16 can be detachably attached to the lower part 3. FIG. 4 shows the machining unit 10 in a state in which the upper part 16 is placed on and coupled to the lower part 3. FIG. 1 shows the transportable machining unit 10 in a state in which the upper part 16 is detached from the lower part 3.

For the coupling of the upper part 16 to the lower part 3, upper part coupling means 28 and lower part coupling means 29 are exemplarily provided. In particular, the upper part coupling means 28 and the lower part coupling means 29 can be used to provide a vertically tension-proof coupling between the lower part 3 and the upper part 16. Purposefully, the upper part coupling means 28 comprises a rotary latch 31 and the lower part coupling means 29 comprises a locking anchor contour 39. Preferably, the upper part coupling means 28 and the lower part coupling means 29 are at least partially arranged in the recess in the front wall 12. In particular, the rotary latch 31 and the locking anchor contour 28 are arranged in the recess or on the middle wall section 58.

In the embodiment shown, the support structure 2 exemplarily has support structure coupling means 6. The support structure coupling means 6 are adapted to provide, in a state in which the support structure 2 together with at least one box-shaped body 21, 22 forms a vertical stack 20, a releasable vertically tension-proof coupling with the at least one box-shaped body 21, 22 as shown in FIG. 4.

The transportable machining unit 10 can be stably accommodated in a stack of box-shaped bodies 21, 22, such as box-shaped containers and/or other transportable machining units 10 by means of the support structure coupling means 6. As can be seen in the figures, the transportable machining unit 10 exemplarily has the basic shape of a system casing. The transportable machining unit 10 shown in the drawings is designed to be accommodated in a stack of further system casings.

The basic shape of the transportable machining unit 10 is defined in particular by the box-shaped support structure 2. The outer surfaces of the support structure 2 preferably represent the housing or the outer housing surfaces of the transportable machining unit 10. The housing or the basic shape of the transportable machining unit 10 in particular has the shape of a system casing. System casings of a system have a base area defined in the system and have coupling means defined in the system so that system casings of a system can be assembled into a stable stack. System casings are widely used, for example, as modular tool boxes for storing hand-held power tools, accessories and/or consumables. If the basic shape or the housing of the machining unit 10 according to the invention is in the form of a system casing, the transportable machining unit 10 can be stowed and transported in a stack of system casings in a practical manner.

The support structure coupling means 6 comprise upper support structure coupling means 7, which are provided on the upper part 16. The upper support structure coupling means 7 are adapted to provide a releasable, vertically tension-proof coupling with the box-shaped body 21 in a state in which a box-shaped body 21 is stacked on the transportable machining unit 10. The upper support structure coupling means 7 comprise a movably supported locking element 9. In the example shown, the locking element 9 comprises a rotary latch 11 rotatably supported on the support structure 2. The rotary latch 11 is arranged on the front wall 12 of the support structure 2. The axis of rotation of the rotary latch 11 is orthogonal to the front wall 12.

The support structure coupling means 6 further comprise lower support structure coupling means 8 provided on the lower part 3. The lower support structure coupling means 8 are adapted to provide a releasable, vertically tension-proof coupling to the box-shaped body 22 in a state in which the transportable machining unit 10 is stacked on a box-shaped body 22. The lower support structure coupling means 8 comprise at least one first locking anchor contour 14 non-movingly arranged on the support structure 2. In the example shown, the first locking anchor contour 14 is arranged on the lower part of the support structure 2 The first locking anchor contour 14 is located on the front wall 12 of the support structure and is arranged centrally on the support structure 2 in relation to the longitudinal direction. The first locking anchor contour 14 is designed as a locking projection and projects from the front wall 12.

The locking element 9 and the first locking anchor contour 14 are arranged in such a way that when two transportable machining units 10 are stacked vertically one above the other, the locking element 9 of one transportable machining unit can be brought into coupling engagement with the first locking anchor contour 14 of the other machining unit.

FIG. 4 shows a stack 20 which comprises the transportable machining unit 10 discussed above, an upper box-shaped body 21 arranged on the transportable machining unit 10, and a lower box-shaped body 22 arranged below the transportable machining unit 10. The two box-shaped bodies 21, 22 in FIG. 4 are exemplarily designed as box-shaped containers. Alternatively, each of the box-shaped bodies 21, 22 can also be designed as an additional machining unit 10.

The two box-shaped bodies 21, 22 together with the transportable machining unit 10 form the vertical stack 20. The box-shaped bodies 21, 22 have body coupling means 23 which cooperate with the support structure coupling means 6 to provide a releasable, vertically tight coupling between the box-shaped bodies 21, 22 and the transportable machining unit 10.

The horizontal cross-section of the transportable machining unit 10 has essentially the same outer contour as the horizontal cross-section of the box-shaped bodies 21, 22. The transportable machining unit 10 is arranged in alignment with the box-shaped bodies 21, 22, so that the transportable machining unit 10 and the box-shaped bodies 21, 22 together form an essentially cuboid stack 20.

The body coupling means 23 may be identical to the support structure coupling means 6. The coupling between the body coupling means 23 and the support structure coupling means 6 can then be carried out in the same way as the coupling described above between support structure coupling means 6 of two transportable machining units 10.

In particular, the body coupling means 23 comprise a locking element 65, preferably in the form of a rotary latch and a locking anchor contour 66.

The locking elements 11, 31 discussed above as well as the locking anchor contours 14 and 39 are preferably provided on the middle wall section 58. The locking elements 11, 31 and the locking anchor contours 14 and 39 are therefore provided in the same recess on the front wall 12 to which the operating device 59 or its operating elements are attached.

1. Transportable machining unit with a tool for machining a workpiece, comprising a box-shaped support structure which can be placed on a support and which has a workpiece support plate which can be used to support the workpiece to be machined, as well as a control device with an operating device arranged on the outside of the support structure, wherein the operating device comprises a first rotary wheel and a second rotary wheel, wherein a first operating parameter associated with an operation of the tool can be entered into the control device via the first rotary wheel and a second operating parameter associated with the operation of the tool can be entered into the control device via the second rotary wheel.

2. Transportable machining unit according to claim 1, wherein a fixed assignment between the rotary wheels and the operating parameters is defined in the control device.

3. Transportable machining unit according to claim 1, wherein the operating device has at least one quick selection button and the control device is designed to set the first and/or second operating parameter to a pre-determined value when the quick selection button is pressed.

4. Transportable machining unit according to claim 1, wherein the operating device has a plurality of quick selection buttons, wherein a respective fixed assignment between the quick selection buttons and the operating parameters is defined in the control device.

5. Transportable machining unit according to claim 4, wherein the rotary wheels and the quick selection buttons are arranged such that the quick selection buttons associated with the first operating parameter and the first rotary wheel are located on a first side of an imaginary dividing line and the quick selection buttons associated with the second operating parameter and the second rotary wheel are located on a second side of the imaginary dividing line.

6. Transportable machining unit according to claim 1, wherein the control device comprises an electrical actuator and is adapted to adjust the position of the tool relative to the workpiece support plate according to the first and/or second operating parameter using the electrical actuator.

7. Transportable machining unit according to claim 6, wherein the electrical actuator is adapted to position the tool along first and second degrees of freedom, and the control device is adapted to adjust the position of the tool along the first degree of freedom in accordance with the first operating parameter using the electrical actuator and to adjust the position of the tool along the second degree of freedom in accordance with the second operating parameter.

8. Transportable machining unit according to claim 6, wherein the electrical adjusting device is designed to displace the tool along a vertical translation axis and/or to pivot it about a horizontal pivot axis.

9. Transportable machining unit according to claim 8, wherein the control device is designed to set the first and/or second operating parameter to a value which corresponds to a maximum and/or minimum displacement along the vertical translation axis and/or a maximum and/or minimum pivoting about the horizontal pivot axis when a quick selection button is pressed.

10. Transportable machining unit according to claim 1, wherein the operating device is arranged on a circumferential wall of the support structure and the axes of rotation of the rotary wheels are aligned orthogonally to the circumferential wall.

11. Transportable machining unit according to claim 11, wherein a recess is provided in the circumferential wall in which the operating device is arranged.

12. Transportable machining unit according to claim 11, wherein the support structure comprises couplers and is adapted to provide, in a state in which the transportable machining unit together with at least one box-shaped body forms a vertical stack, provide a releasable, vertically tension-proof coupling with the at least one box-shaped body, wherein the couplers are at least partially arranged in the recess.

13. Transportable machining unit according to claim 1, wherein the operating device comprises a display which is designed to display the first and/or the second position parameter.

14. Transportable machining unit according to claim 13, wherein the display is arranged above the rotary wheels on a circumferential wall of the support structure and is angled upwards relative to the circumferential wall.

15. Transportable machining unit according to claim 1, wherein at least one of the rotary wheels comprises an incremental encoder.
